(19) United States
(12) Patent Application Publication
(10) Pub. No.: US 2025/0208470 A1
(43) Pub. Date: Jun. 26, 2025

(54) ELECTRONIC DEVICE

(71) Applicant: Innolux Corporation, Miaoli County (TW)

(72) Inventors: Chia-Hao Tsai, Miaoli County (TW); Ming-Jou Tai, Miaoli County (TW)

(73) Assignee: Innolux Corporation, Miaoli County (TW)

(21) Appl. No.: 18/957,855

(22) Filed: Nov. 24, 2024

(30) Foreign Application Priority Data
Dec. 20, 2023 (CN) 202311762907.7

(51) Int. Cl. G02F 1/1362; G02F 1/1368

(52) U.S. Cl. CPC G02F 1/136222; G02F 1/1368

(57) ABSTRACT

An electronic device including a substrate, a driving circuit layer, a color filter layer and a first transparent organic layer is provided. The driving circuit layer is disposed on the substrate. The color filter layer is disposed on the driving circuit layer and has a first through hole. The first transparent organic layer is disposed on the color filter layer. At least a part of the first transparent organic layer is disposed in the first through hole. The first transparent organic layer covers at least a part of an upper surface of the color filter layer. The electronic device disclosed of the disclosure mitigates problems of light leakage and electrode overexposure or improves quality of display images.

### CROSS-REFERENCE TO RELATED APPLICATION

This application claims the priority benefit of China application serial no. 202311762907.7, filed on Dec. 20, 2023. The entirety of the above-mentioned patent application is hereby incorporated by reference herein and made a part of this specification.

### BACKGROUND

### Technical Field

The disclosure relates to an electronic device, and particularly relates to an electronic device capable of improving quality of display images.

### Description of Related Art

Electronic devices or spliced electronic devices have been widely used in different fields such as communication, display, automobile or aviation. Along with the rapid development of electronic devices, electronic devices are developed to have a thinner and lighter design. Therefore, requirements for reliability or quality of the electronic devices become higher.

### SUMMARY

The disclosure is directed to an electronic device, which is adapted to mitigate problems of light leakage and electrode overexposure or improve quality of display images.

An embodiment of the disclosure provides an electronic device including a substrate, a driving circuit layer, a color filter layer and a first transparent organic layer. The driving circuit layer is disposed on the substrate. The color filter layer is disposed on the driving circuit layer and has a first through hole. The first transparent organic layer is disposed on the color filter layer. At least a part of the first transparent organic layer is disposed in the first through hole. The first transparent organic layer covers at least a part of an upper surface of the color filter layer.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic top view of an electronic device according to a first embodiment of the disclosure.

FIG. 2 is a schematic cross-sectional view of the electronic device of FIG. 1 along a section line I-I′.

FIG. 3 is a schematic top view of an electronic device according to a second embodiment of the disclosure.

FIG. 4 is a schematic cross-sectional view of the electronic device of FIG. 3 along a section line II-II′.

FIG. 5 is a schematic cross-sectional view of an electronic device according to a third embodiment of the disclosure.

FIG. 6 is a schematic cross-sectional view of an electronic device according to a fourth embodiment of the present disclosure.

FIG. 7 is a schematic cross-sectional view of an electronic device according to a fifth embodiment of the disclosure.

FIG. 8 is a schematic cross-sectional view of an electronic device according to a sixth embodiment of the disclosure.

FIG. 9 is a schematic cross-sectional view of an electronic device according to a seventh embodiment of the disclosure.

FIG. 10 is a schematic cross-sectional view of an electronic device according to an eighth embodiment of the disclosure.

### DESCRIPTION OF THE EMBODIMENTS

The disclosure may be understood by referring to the following detailed description with reference of the accompanying drawings. It should be noted that, in order to facilitate the reader's understanding and the conciseness of the drawings, the multiple drawings in the disclosure only depict a part of an electronic device, and specific elements in the drawings are not drawn according to actual scales. In addition, the number and size of each element in the figures are only for illustration, and are not used to limit the scope of the disclosure. For example, for clarity's sake, relative size, thickness and position of each film layer, region and/or structure may be reduced or enlarged.

In the following description and claims, the words “have” and “include” are open-ended words, so they should be interpreted as “including but not limited to . . . ”.

It should be understood that when an element or film layer is referred to as being “on” or “connected” to another element or film layer, the element or film layer may be directly on the other element or film layer, or directly connected to the other element or film layer, or there is an intervening element or film layer there between (an indirect situation). Conversely, when an element or film layer is referred to be “directly” on or “directly connected” to another element or film layer, there is no intervening element or film layer there between.

Although terms “first”, “second”, “third” . . . may be used to describe various constituent elements, the constituent elements are not limited to these terms. These terms are only used to distinguish a single element from other elements in the specification. The same terms may not be used in the claims, but may be replaced by first, second, third . . . according to the order in which the elements are declared in the claims. Therefore, in the following description, a first constituent element may be a second constituent element in the claims.

In the specification, the terms “about”, “approximately”, “substantially” and “roughly” usually mean within 10%, or within 5%, or within 3%, or within 2%, or within 1%, or within 0.5% of a given value or range. The quantities given here are approximate quantities, i.e., in the absence of specific instructions for “about”, “approximately”, “substantially”, and “roughly”, the meanings of “about”, “approximately”, “substantially” and “roughly” may still be implied.

In some embodiments of the disclosure, terms related to bonding and connecting, such as “connect”, “interconnect”, etc., unless otherwise defined, may mean that two structures are in direct contact, or may also mean that two structures are not in direct contact, and there are other structures located between these two structures. And the terms related to bonding and connecting may also include the situation where both structures are movable, or both structures are fixed. In addition, the term “couple” includes any direct and indirect means of electrical connection.

In some embodiments of the disclosure, an optical microscope (OM), a scanning electron microscope (SEM), a thin film thickness profilometer (α-step), an elliptical thickness gauge, or other suitable methods may be used to measure an area, width, thickness or height of each element, or a distance or spacing between the elements. In detail, according to some embodiments, a scanning electron microscope may be used to obtain a cross-sectional structural image including the elements to be measured, and measure the area, width, thickness or height of each element, or the distance or spacing between the elements.

The electronic device of the disclosure may include a display device, a light emitting device, a backlight device, a virtual reality device, an augmented reality device, an antenna device, a communication device, a sensing device or a splicing device, but the disclosure is not limited thereto. The electronic device may be a bendable or flexible electronic device. The electronic device may include, for example, liquid crystal, light emitting diode, fluorescence, phosphor, other suitable display media, or a combination of the above, but the disclosure is not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy or ultrasonic waves, but the disclosure is not limited thereto. The electronic device may, for example, include electronic elements such as passive elements and active elements, such as capacitors, resistors, inductors, diodes, transistors, etc. Diodes may include light emitting diodes or photodiodes. The light emitting diode may include, for example, an organic light emitting diode (OLED), a mini LED, a micro LED or a quantum dot (QD) LED (which may be, for example, QLED or QDLED) or other suitable materials and the materials may be arbitrarily arranged and combined, but the disclosure is not limited thereto. The antenna device may be, for example, a phase array antenna, but the disclosure is not limited thereto. The splicing device may be, for example, a display splicing device or an antenna splicing device, but the disclosure is not limited thereto. It should be noted that the electronic device may be any arrangement and combination of the above, but the disclosure is not limited thereto. In addition, a shape of the electronic device may include a rectangular shape, a circular shape, a polygonal shape, a shape with curved edges, or other suitable shapes. The electronic device may have a peripheral system such as a driving system, a control system, and a light source system, etc., to support a display device, an antenna device, a wearable device (for example, including augmented reality or virtual reality), a vehicle-mounted device (for example, including a vehicle windshield) or a splicing device. The electronic device is used as an example to describe the content of the disclosure below, but the disclosure is not limited thereto.

It should be noted that in the following embodiments, features of several different embodiments may be replaced, reorganized, and mixed to complete other embodiments without departing from the spirit of the disclosure. Features in various embodiments may be arbitrarily mixed and matched as long as they do not violate the spirit of the disclosure or conflict with each other.

Reference will now be made in detail to the exemplary embodiments of the present disclosure, examples of which are illustrated in the accompanying drawings. Whenever possible, the same reference numbers are used in the drawings and description to refer to the same or similar parts.

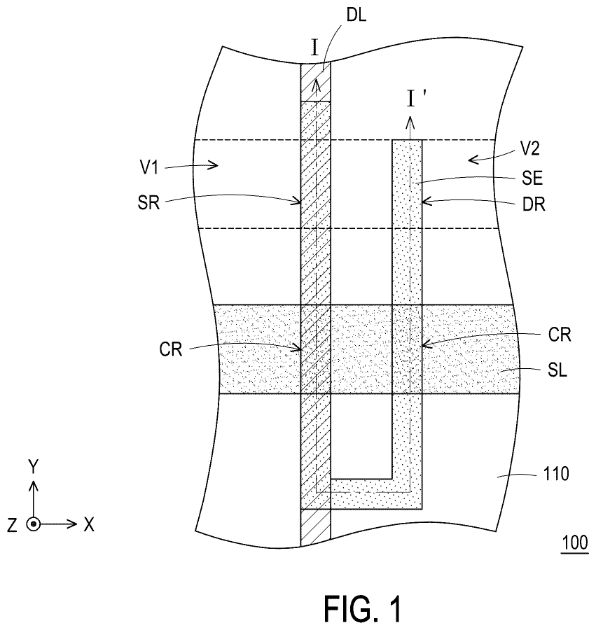

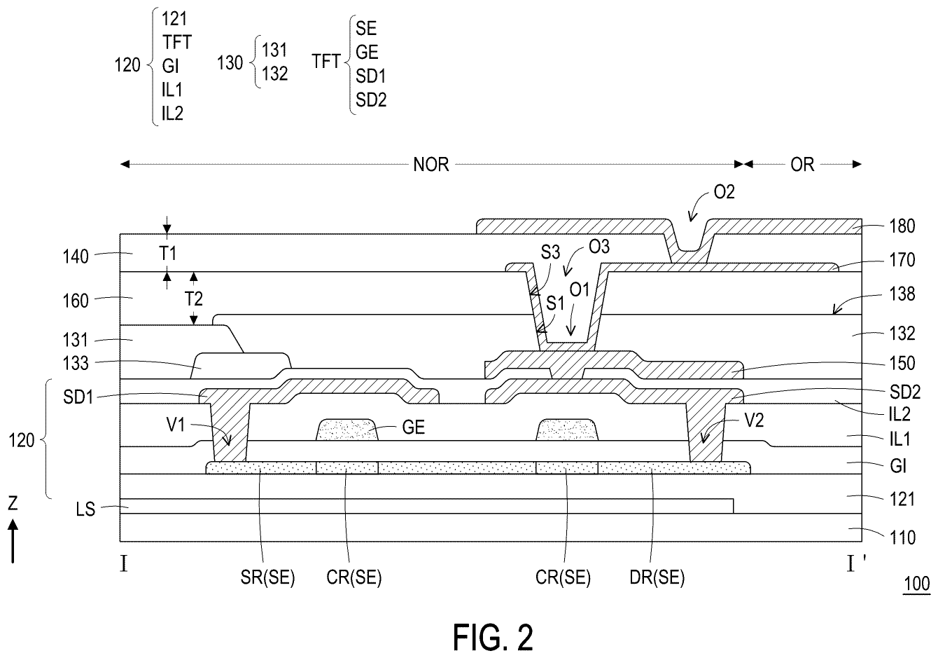

FIG. 1 is a schematic top view of an electronic device according to a first embodiment of the disclosure. FIG. 2 is a schematic cross-sectional view of the electronic device of FIG. 1 along a section line I-I′. For clarity of the drawing and convenience of explanation, some components in the electronic device are omitted in FIG. 1.

Referring to FIG. 1 and FIG. 2, an electronic device 100 of the embodiment may include a substrate 110, a driving circuit layer 120, a color filter layer 130 and a first transparent organic layer 140. In addition, in the embodiment, the electronic device 100 may further include a scan line SL, a data line DL, a shielding layer LS, a transfer pad 150, a second transparent organic layer 160, a connection electrode 170, a pixel electrode 180, an opening region OR, and a non-opening region NOR.

The opening region OR may be a region through which light may pass; the non-opening region NOR may be a region through which light cannot pass, and the non-opening region NOR may include any film layer that may be used to shield light (for example, it may be an opaque region such as a wiring region, a transistor region, etc.). The substrate 110 may include a rigid substrate, a flexible substrate, or a combination of the above. For example, a material of the substrate 110 may include glass, quartz, sapphire, ceramic, polycarbonate (PC), polyimide (PI), polyethylene terephthalate (PET), other suitable substrate materials, or combinations of the above, but the disclosure is not limited thereto.

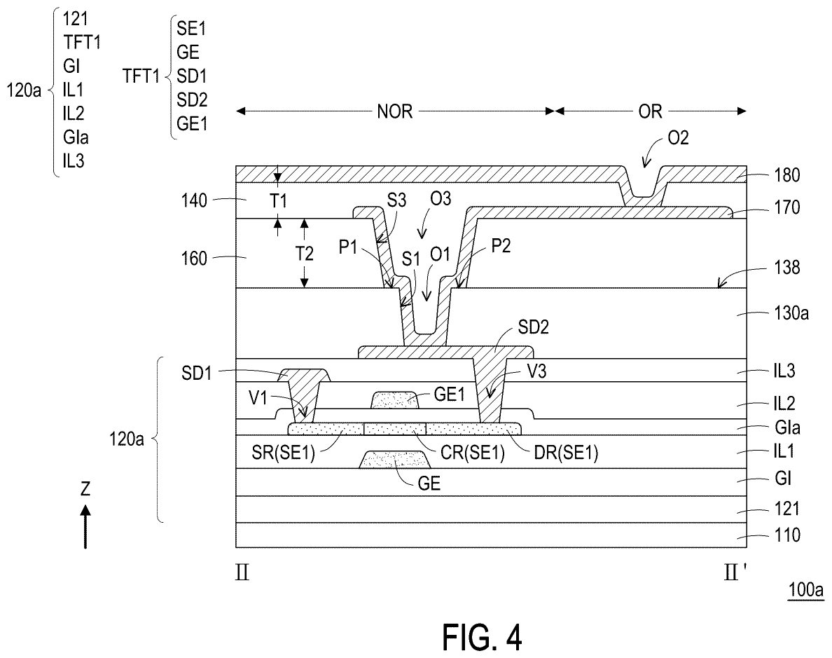

The shielding layer LS is disposed between the driving circuit layer 120 and the substrate 110. In the embodiment, a material of the shielding layer LS may be, for example, a metal material or a light-shielding material. In some embodiments, the electronic device may also be provided without a shielding layer if necessary (as shown in FIG. 4).

The driving circuit layer 120 is disposed on the substrate 110. The driving circuit layer 120 includes an insulating layer 121, a thin film transistor TFT, a gate insulating layer GI, an insulating layer IL1 and an insulating layer IL2. The thin film transistor TFT is at least partially disposed in the non-opening region NOR, and the thin film transistor TFT has a semiconductor layer SE, a gate electrode GE, a source electrode SD1 and a drain electrode SD2.

Specifically, the insulating layer 121 is disposed on the substrate 110. The semiconductor layer SE is disposed on the insulating layer 121. The semiconductor layer SE may include a source region SR, a channel region CR, and a drain region DR. A material of the semiconductor layer SE may be low-temperature polycrystalline silicon (LTPS), amorphous silicon, poly-silicon, oxide semiconductor layer, other suitable materials or a combination of the above materials, but the disclosure is not limited thereto. A shape of the semiconductor layer SE may be a U-shape (as shown in FIG. 1), but the disclosure is not limited thereto. The gate insulating layer GI is disposed on the semiconductor layer SE. The gate electrode GE is disposed on the gate insulating layer GI. An overlapping region of the semiconductor layer SE and the gate electrode GE in a direction Z (i.e., a normal direction of the substrate 110) may be regarded as a channel region CR. The insulating layer IL1 is disposed on the gate electrode GE, and the insulating layer IL1 is disposed between the insulating layer IL2 and the gate insulating layer GI. The insulating layer IL1 may cover the gate insulating layer GI and the gate electrode GE. The source electrode SD1 and the drain electrode SD2 are respectively disposed on the insulating layer IL1. The source electrode SD1 may be electrically connected to the source region SR of the semiconductor layer SE through an opening V1 penetrating through the insulating layer IL1 and the gate insulating layer GI, and the drain electrode SD2 may be electrically connected to the drain region DR of the semiconductor layer SE through an opening V2 penetrating through the insulating layer IL1 and the gate insulating layer GI. The insulating layer IL2 is disposed on the source electrode SD1 and the drain electrode SD2, and the insulating layer IL2 may cover the insulating layer IL1, the source electrode SD1 and the drain electrode SD2. In the embodiment, the insulating layer 121, the gate insulating layer GI, the insulating layer IL1 and the insulating layer IL2 may have a single-layer structure or a multi-layer structure, and may include, for example, organic materials, inorganic materials or a combination thereof, but the invention is not limited thereto.

Although the thin film transistor TFT in the embodiment is a top gate thin film transistor, the disclosure is not limited thereto; in some embodiments, the thin film transistor may also be a bottom gate thin film transistor, and/or a dual gate or double gate thin film transistor.

In the embodiment, a direction X, a direction Y and the direction Z are respectively different directions. For example, the direction X is an extending direction of the scan line SL, the direction Y is an extending direction of the data line DL, and the direction Z may be, for example, the normal direction of the substrate 110. The direction X is substantially perpendicular to the direction Y, and the direction X and the direction Y are respectively substantially perpendicular to the direction Z, but the disclosure is not limited thereto.

The scan line SL and data line DL are provided on the substrate 110. The scan line SL extends in the direction X, and the data line DL extends in the direction Y. The scan line SL may be electrically connected to the gate electrode GE of the thin film transistor TFT, and the data line DL may be electrically connected to the source electrode SD1 of the thin film transistor TFT.

The transfer pad 150 is disposed on the insulating layer IL2 of the driving circuit layer 120, and the transfer pad 150 is disposed between the pixel electrode 180 and the drain electrode SD2. The transfer pad 150 may overlap the drain electrode SD2 in the direction Z. The transfer pad 150 may electrically connect the pixel electrode 180 and the drain electrode SD2. In the embodiment, the transfer pad 150 and the drain electrode SD2 may be respectively a single layer or multi-layer conductive material, and the conductive material may include metal, other suitable transparent or opaque conductive materials, or a combination thereof, but the disclosure is not limited thereto. In some embodiments, the transfer pad 150 and/or the insulating layer IL2 may be omitted, and the drain electrode SD2 may be directly electrically connected to the connection electrode 170.

The color filter layer 130 is disposed on the driving circuit layer 120. The color filter layer 130 is disposed between the pixel electrode 180 and the driving circuit layer 120, and the color filter layer 130 is disposed between the connection electrode 170 and the drain electrode SD2. The color filter layer 130 includes a filter layer 131 and a filter layer 132. The light-shielding layer 133 is disposed between the filter layer 131 and the filter layer 132. In the direction Z, an overlapping portion of the filter layer 131 and the filter layer 132 may be regarded as a light-shielding structure to have a light-shielding effect, and the overlapping portion of the filter layer 131 and the filter layer 132 may overlap the light-shielding layer 133. In the embodiment, the light-shielding layer 133 may be, for example, a black matrix layer (BM) or a film layer with a low transmittance material, but the disclosure is not limited thereto. Moreover, in the embodiment, the color filter layer 130 has a first through hole O1. The first through hole O1 is provided in the non-opening region NOR. The first through hole O1 has a side wall S1, and the first through hole O1 may expose a part of the transfer pad 150.

The second transparent organic layer 160 is disposed between the color filter layer 130 and the first transparent organic layer 140. The second transparent organic layer 160 includes a third through hole O3. The third through hole O3 is provided in the non-opening region NOR. The third through hole O3 may overlap the first through hole O1 in the direction Z. The third through hole O3 may be connected to the first through hole O1 and expose a part of the transfer pad 150 or the drain electrode SD2. The third through hole O3 has a side wall S3, and the side wall S3 of the third through hole O3 may be aligned with and connected to the side wall S1 of the first through hole O1. In addition, the second transparent organic layer 160 has a thickness T2 (for example, a maximum thickness), and the thickness T2 is, for example, a thickness of the second transparent organic layer 160 measured along the direction Z.

The connection electrode 170 is disposed on the second transparent organic layer 160, and the connection electrode 170 is disposed between the first transparent organic layer 140 and the second transparent organic layer 160. The connection electrode 170 may also be disposed in the third through hole O3 and the first through hole O1, so that the connection electrode 170 may be electrically connected to the transfer pad 150 or the drain electrode SD2 through the third through hole O3 and the first through hole O1. The connection electrode 170 may include any suitable transparent conductive material, such as indium tin oxide (ITO), but the disclosure is not limited thereto.

The first transparent organic layer 140 is disposed on the color filter layer 130. The first transparent organic layer 140 is disposed on the second transparent organic layer 160 and the connection electrode 170. At least a part of the first transparent organic layer 140 may be disposed in the first through hole O1 and the third through hole O3. The first transparent organic layer 140 may cover at least a part of an upper surface 138 of the color filter layer 130 (i.e., a surface of the color filter layer 130 facing away from the driving circuit layer 120). In the embodiment, “cover” means that two portions are at least partially overlapped, the two portions may be in direct contact, or there are other elements between the two portions. The “upper surface 138” refers to a surface of the color filter layer 130 that is substantially parallel to the substrate 110. Therefore, a surface of the color filter layer 130 that is not parallel to the substrate 110 is a side surface.

In the embodiment, since the liquid crystal and the transparent electrode (such as the connection electrode 170) corresponding to the through hole formed after the third through hole O3 is connected to the first through hole O1 are respectively prone to have problems of light leakage due to poor liquid crystal arrangement and transparent electrode overexposure, in the electronic device 100 of the embodiment, at least a part of the first transparent organic layer 140 is disposed in the first through hole O1 and the third through hole O3 to mitigate the problems of light leakage and electrode overexposure, which may improve display quality, process feasibility or product yield.

The first transparent organic layer 140 includes a second through hole O2. The second through hole O2 is provided in the non-opening region NOR. The second through hole O2 does not overlap the third through hole O3 and the first through hole O1 in the direction Z. The second through hole O2 may expose a part of the connection electrode 170. In other embodiments, the second through hole O2 may be disposed in the opening region OR, but the disclosure is not limited thereto. In addition, the first transparent organic layer 140 has a thickness T1, and the thickness T1 is, for example, a thickness of the first transparent organic layer 140 measured along the direction Z. In the embodiment, the thickness T1 of the first transparent organic layer 140 may be, for example, less than 0.5 μm, so that the liquid crystal and the pixel electrode 180 at a place corresponding to the second through hole O2 are less likely to have the problems of light leakage due to poor liquid crystal arrangement and electrode overexposure, but the disclosure is not limited thereto. In some embodiments, when the thickness of the first transparent organic layer is greater than 0.5 μm, a leveling effect of the third through hole O3 and the first through hole O1 may be improved.

In the embodiment, a sum of the thickness T1 of the first transparent organic layer 140 and a thickness T2 of the second transparent organic layer 160 may be, for example, less than 6 μm, so as to mitigate a problem of color shift or transmittance reduction in the opening region OR, but the disclosure is not limited thereto. In some embodiments, when the thickness T2 of the second transparent organic layer 160 is less than 0.5 μm, a depth of the third through hole O3 may be reduced to improve the leveling effect of the first transparent organic layer 140 in filling the third through hole O3 and the first through hole O1.

In the embodiment, when fabricating the first transparent organic layer 140 and/or the second transparent organic layer 160, the first transparent organic layer 140 and/or the second transparent organic layer 160 of a predetermined thickness may be directly formed, but the disclosure is not limited thereto. In some embodiments, in order to improve the leveling effect, a film layer with a thickness thicker than the predetermined thickness may be formed first, and then an etching process or a secondary photolithography process may be used for thinning to obtain the first transparent organic layer 140 and/or the second transparent organic layer 160 with the predetermined thickness.

In the embodiment, the “transparent organic layer” (including the first transparent organic layer 140 and the second transparent organic layer 160) refers to a colorless organic layer, or refers to that a transmittance of the “transparent organic layer” may be greater than a transmittance of the color filter layer.

The pixel electrode 180 is disposed on the first transparent organic layer 140 and in the second through hole O2, so that the pixel electrode 180 may be electrically connected to the connection electrode 170 through the second through hole O2. In addition, the pixel electrode 180 may be electrically connected to the drain electrode SD2 through the connection electrode 170 and the transfer pad 150.

Other examples will be listed below as illustrations. It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

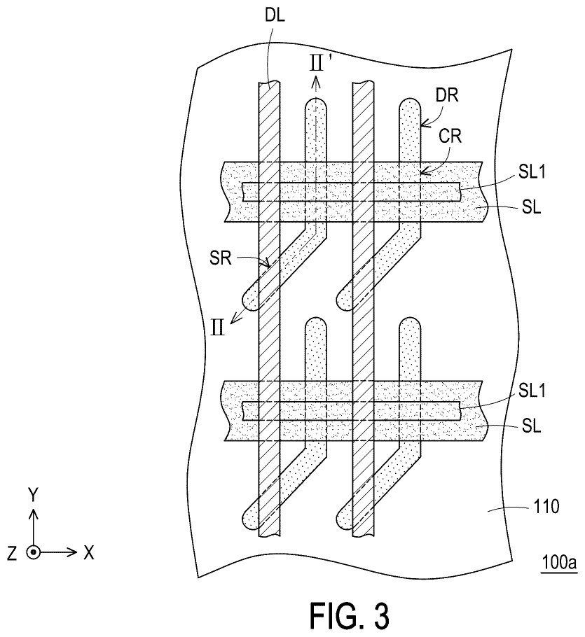

FIG. 3 is a schematic top view of an electronic device according to a second embodiment of the disclosure. FIG. 4 is a schematic cross-sectional view of the electronic device of FIG. 3 along a section line II-II′. Referring to FIG. 3 to FIG. 4 and FIG. 1 to FIG. 2 at the same time, an electronic device 100a of the embodiment is similar to the electronic device 100 of FIG. 1 to FIG. 2, and an only difference there between is that: in the electronic device 100a of the embodiment, a material of the semiconductor layer SE1 may be a metal oxide, such as indium gallium zinc oxide (IGZO), but the disclosure is not limited thereto. In addition, the electronic device 100a of the embodiment further includes a scan line SL1.

Specifically, referring to FIG. 3 to FIG. 4, in the embodiment, a driving circuit layer 120a includes an insulating layer 121, a thin film transistor TFT1, a gate insulating layer GI, an insulating layer IL1, an insulating layer IL2, and a gate insulating layer GIa. and insulating layer IL3. The thin film transistor TFT1 is at least partially disposed in the non-opening region NOR, and the thin film transistor TFT1 has a semiconductor layer SE1, a gate electrode GE, a source electrode SD1, a drain electrode SD2, and a gate electrode GE1. In the embodiment, the thin film transistor TFT1 may be a dual-gate thin film transistor, but the disclosure is not limited thereto.

The insulating layer 121 is disposed on the substrate 110. The gate insulation layer GI is disposed on the insulation layer 121. The gate electrode GE is disposed on the gate insulating layer GI. The insulating layer IL1 is disposed on the gate electrode GE, and the insulating layer IL1 may cover the gate insulating layer GI and the gate electrode GE. The semiconductor layer SE1 is disposed on the insulating layer IL1, and the semiconductor layer SE1 is disposed between the gate electrode GE1 and the gate electrode GE. The semiconductor layer SE1 may include a source region SR, a channel region CR, and a drain region DR. A shape of the semiconductor layer SE1 may be a <-shape (as shown in FIG. 3), but the disclosure is not limited thereto. The gate insulating layer GIa is disposed on the semiconductor layer SE1, and the gate insulating layer GIa may cover the insulating layer IL1 and the semiconductor layer SE1. The gate electrode GE1 is disposed on the gate insulating layer GIa. A region where the semiconductor layer SE and the gate electrode GE1 are overlapped in the direction Z may be regarded as the channel region CR, and the gate electrode GE may overlap the channel region CR in the direction Z. The insulating layer IL2 is disposed on the gate electrode GE1, and the insulating layer IL2 may cover the gate insulating layer GIa and the gate electrode GE1. The source electrode SD1 is disposed on the insulating layer IL2, and the source electrode SD1 may be electrically connected to the source region SR of the semiconductor layer SE1 through the opening V1 penetrating through the insulating layer IL2 and the gate insulating layer GIa. The insulating layer IL3 is disposed on the source electrode SD1, and the insulating layer IL3 may cover the insulating layer IL2 and the source electrode SD1. The drain electrode SD2 is disposed on the insulating layer IL3, and the drain electrode SD2 may be electrically connected to the drain region DR of the semiconductor layer SE1 through an opening V3 penetrating through the insulating layer IL2, the insulating layer IL3, and the gate insulating layer GIa. In the embodiment, the insulating layer 121, the gate insulating layer GI, the gate insulating layer GIa, the insulating layer IL1, the insulating layer IL2, and the insulating layer IL3 may be a single-layer structure or a multi-layer structure, and may include, for example, organic materials, inorganic materials or combinations thereof, but the disclosure is not limited thereto. The drain electrode SD2 may be a single layer or multi-layer conductive material, and the material may include metal, other suitable transparent or opaque conductive materials, or a combination thereof, but the disclosure is not limited thereto.

The scan line SL may be electrically connected to the gate electrode GE of the thin film transistor TFT1, and the scan line SL1 may be electrically connected to the gate electrode GE1 of the thin film transistor TFT1.

The color filter layer 130a is disposed on the drain electrode SD2, and the color filter layer 130a may cover the insulating layer IL3 and the drain electrode SD2. The first through hole O1 of the color filter layer 130a may expose a part of the drain electrode SD2.

The third through hole O3 of the second transparent organic layer 160 may be connected to the first through hole O1 to expose a part of the drain electrode SD2 and a part of the upper surface 138 of the color filter layer 130a. The third through hole O3 has a side wall S3, a bottom plane P1, and a bottom plane P2. The side wall S3 of the third through hole O3 is not aligned with the side wall S1 of the first through hole O1, and the side wall S3 of the third through hole O3 may be connected to the side wall S1 of the first through hole O1 through the bottom plane Pl or the bottom plane P2.

The connection electrode 170 may be electrically connected to the drain electrode SD2 through the third through hole O3 and the first through hole O1.

The second through hole O2 of the first transparent organic layer 140 is provided in the opening region OR. The second through hole O2 does not overlap the third through hole O3 and the first through hole O1 in the direction Z. In other embodiments, the second through hole O2 may also be provided in the non-opening region NOR, which is not limited by the disclosure.

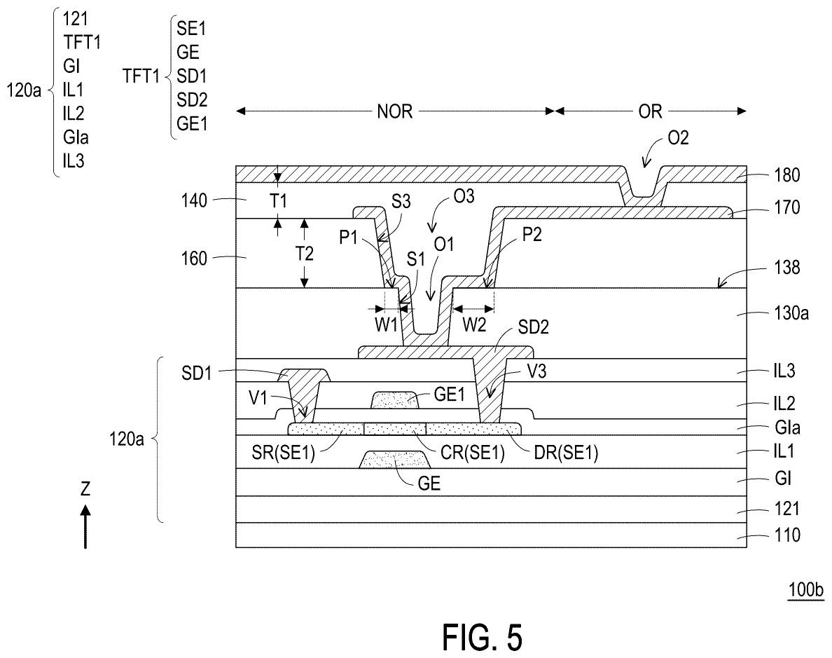

FIG. 5 is a schematic cross-sectional view of an electronic device according to a third embodiment of the disclosure. Referring to FIG. 5 and FIG. 4 at the same time, an electronic device 100b of the embodiment is similar to the electronic device 100a in FIG. 4, and an only difference there between is that in the electronic device 100b of the embodiment, a width W1 of the bottom plane P1 of the third through hole O3 is different from a width W2 of the bottom plane P2.

Specifically, referring to FIG. 5, in the embodiment, the width W1 of the bottom plane P1 may be, for example, smaller than the width W2 of the bottom plane P2, but the disclosure is not limited thereto. The width W1 is, for example, a width of the bottom plane P1 measured along the direction X, and the width W2 is, for example, a width of the bottom plane P2 measured along the direction X.

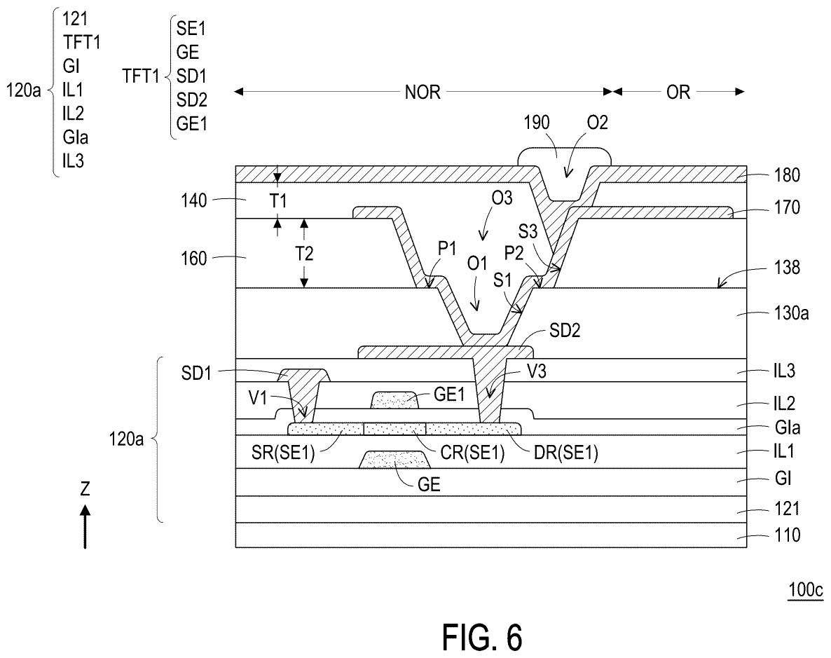

FIG. 6 is a schematic cross-sectional view of an electronic device according to a fourth embodiment of the present disclosure. Referring to FIG. 6 and FIG. 4 at the same time, an electronic device 100c of the embodiment is similar to the electronic device 100a in FIG. 4, and an only difference there between is that in the electronic device 100c of the embodiment, the second through hole O2 may be provided in the non-opening region NOR, and the second through hole O2 may partially overlap the third through hole O3 in the direction Z. In addition, the electronic device 100c of the embodiment may further include a third transparent organic layer 190.

Specifically, referring to FIG. 6, in the embodiment, the second through hole O2 may at least partially overlap the side wall S3 of the third through hole O3 in the direction Z, and the second through hole O2 may expose the connection electrode 170 on the side wall S3, but the disclosure is not limited thereto. In some embodiments, the second through hole may also overlap the bottom plane P2 of the third through hole in the direction Z, and the second through hole may expose the connection electrode located on the bottom plane P2.

The third transparent organic layer 190 is disposed on the pixel electrode 180. In addition, at least a part of the third transparent organic layer 190 may also be disposed in the second through hole O2, so that the liquid crystal and the pixel electrode 180 at a place corresponding to the second through hole O2 are less likely to have the problems of light leakage due to poor liquid crystal arrangement and electrode overexposure.

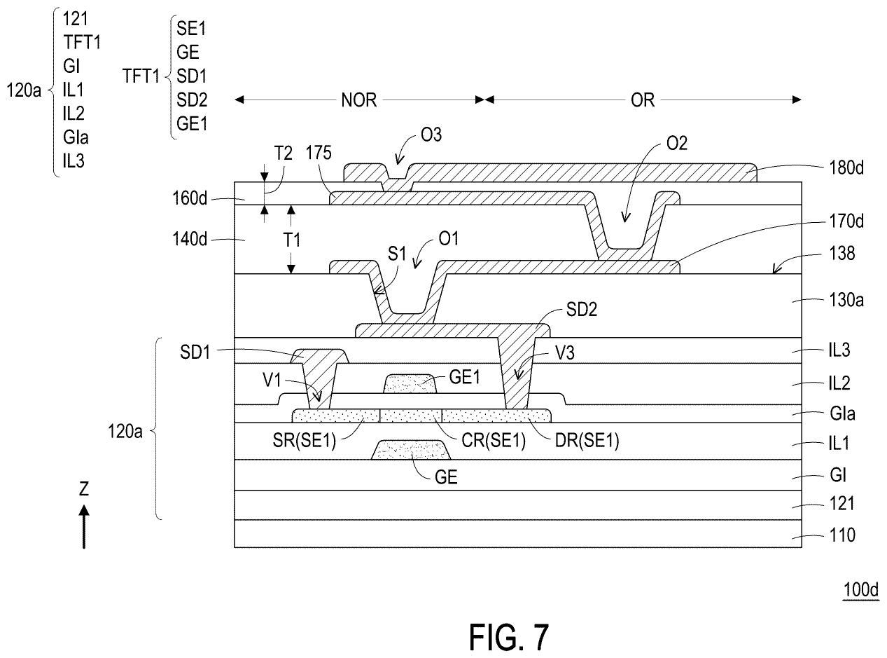

FIG. 7 is a schematic cross-sectional view of an electronic device according to a fifth embodiment of the disclosure. Referring to FIG. 7 and FIG. 4 at the same time, an electronic device 100d of this embodiment is similar to the electronic device 100a in FIG. 4, and an only difference there between is that in the electronic device 100d of the embodiment, a second transparent organic layer 160d is disposed on the first transparent organic layer 140d. In addition, the electronic device 100d of the embodiment may further include a connection electrode 175.

Specifically, referring to FIG. 7, in the embodiment, the connection electrode 170d is disposed on the color filter layer 130a, and the connection electrode 170d is disposed between the first transparent organic layer 140d and the color filter layer 130a. The connection electrode 170d may also be disposed in the first through hole O1, so that the connection electrode 170d may be electrically connected to the drain electrode SD2 through the first through hole O1.

The first transparent organic layer 140d is disposed on the connection electrode 170d, and the first transparent organic layer 140d is disposed between the second transparent organic layer 160d and the color filter layer 130a. The first transparent organic layer 140d may cover at least a part of the upper surface 138 of the color filter layer 130a. At least a part of the first transparent organic layer 140 may also be disposed in the first through hole O1. The second through hole O2 of the first transparent organic layer 140 may be disposed in the opening region OR. The second through hole O2 does not overlap the third through hole O3 and the first through hole O1 in the direction Z. The second through hole O2 may expose a part of the connection electrode 170d.

The connection electrode 175 is disposed on the first transparent organic layer 140d, and the connection electrode 175 is disposed between the second transparent organic layer 160d and the first transparent organic layer 140d. The connection electrode 175 may also be disposed in the second through hole O2, so that the connection electrode 175 may be electrically connected to the connection electrode 170d through the second through hole O2. Materials of the connection electrode 170d and the connection electrode 175 may be the same as or similar to the material of the aforementioned connection electrode 170, which will not be repeated.

The second transparent organic layer 160d is disposed on the connection electrode 175, and the second transparent organic layer 160d is disposed between the pixel electrode 180d and the first transparent organic layer 140d. The third through hole O3 of the second transparent organic layer 160d is provided in the non-opening region NOR. The third through hole O3 may expose a part of the connection electrode 175. The third through hole O3 may overlap the first through hole O1 in the direction Z, and the third through hole O3 does not overlap the second through hole O2 in the direction Z. The third through hole O3 is not directly connected to the first through hole O1.

In the embodiment, the thickness T2 of the second transparent organic layer 160d may be, for example, less than the thickness T1 of the first transparent organic layer 140d, and the thickness T2 of the second transparent organic layer 160d may be, for example, less than 0.5 μm, so that the liquid crystal and the pixel electrode 180d at a place corresponding to the third through hole O3 are less likely to have the problems of light leakage due to poor liquid crystal arrangement and electrode overexposure, but the disclosure is not limited thereto.

In the embodiment, a sum of the thickness T1 of the first transparent organic layer 140d and the thickness T2 of the second transparent organic layer 160d may be, for example, less than 6 μm to reduce the problem of color shift or transmittance reduction in the opening region OR, but the disclosure is not limited thereto.

In the embodiment, when fabricating the first transparent organic layer 140d and/or the second transparent organic layer 160d, the first transparent organic layer 140d and/or the second transparent organic layer 160d of a predetermined thickness may be directly formed, but the disclosure is not limited thereto. In some embodiments, in order to improve the leveling effect, a film layer with a thickness thicker than the predetermined thickness may be formed first, and then an etching process or a secondary photolithography process may be used for thinning to obtain the first transparent organic layer 140d and/or the second transparent organic layer 160d with the predetermined thickness.

In the embodiment, since the second through hole O2 is not directly connected to the first through hole O1 (in other words, the second through hole O2 does not overlap with the first through hole O1), the leveling effect of the first transparent organic layer 140d in filling the first through hole O1 and the leveling effect of the second transparent organic layer 160d in filling the second through hole O2 may be improved, so that the liquid crystal and the pixel electrode 170d (or the pixel electrode 175) at a place corresponding to the first through hole O1 (or the second through hole O2) are less likely to have the problems of light leakage due to poor liquid crystal arrangement and electrode overexposure.

The pixel electrode 180d is disposed on the second transparent organic layer 160d and in the third through hole O3, so that the pixel electrode 180d may be electrically connected to the connection electrode 175 through the third through hole O3. In addition, the pixel electrode 180d may be electrically connected to the drain electrode SD2 through the connection electrode 175 and the connection electrode 170d.

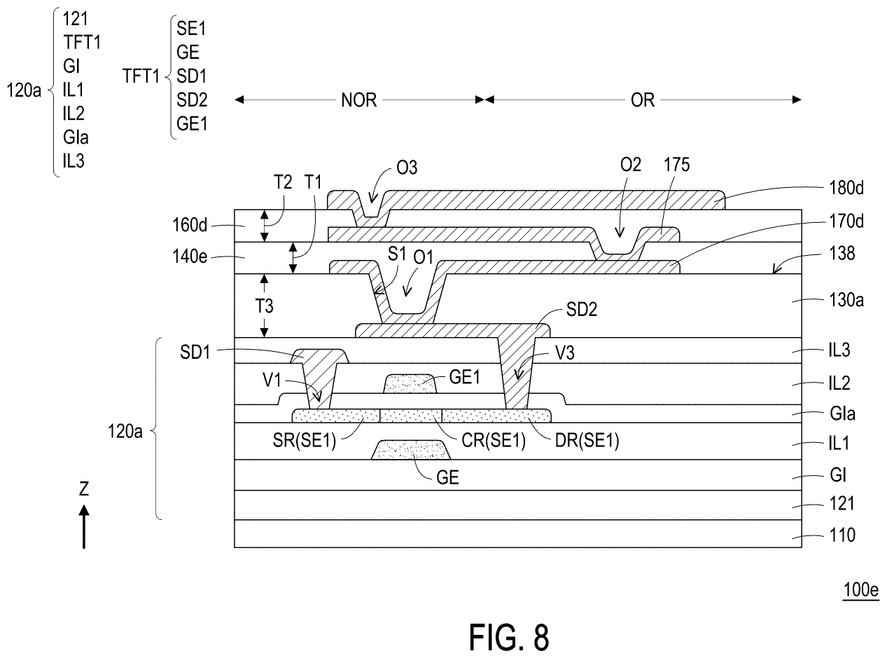

FIG. 8 is a schematic cross-sectional view of an electronic device according to a sixth embodiment of the disclosure. Referring to FIG. 8 and FIG. 7 at the same time, an electronic device 100e of the embodiment is similar to the electronic device 100d in FIG. 7, and an only difference there between is that in the electronic device 100e of the embodiment, the thickness T1 of the first transparent organic layer 140e may be, for example, less than 0.5 μm. Therefore, the leveling effect of the second transparent organic layer 160d in filling the second through hole O2 of the first transparent organic layer 140e may be improved without largely affecting the transmittances of the opening region OR and the non-opening region NOR, thereby improving the overall display quality.

In the embodiment, the color filter layer 130a has a thickness T3, and the thickness T3 of the color filter layer 130a may be, for example, greater than the thickness T1 of the first transparent organic layer 140e or the thickness T2 of the second transparent organic layer 160d, but the disclosure is not limited thereto. The thickness T3 is, for example, a thickness of the color filter layer 130a measured along the direction Z.

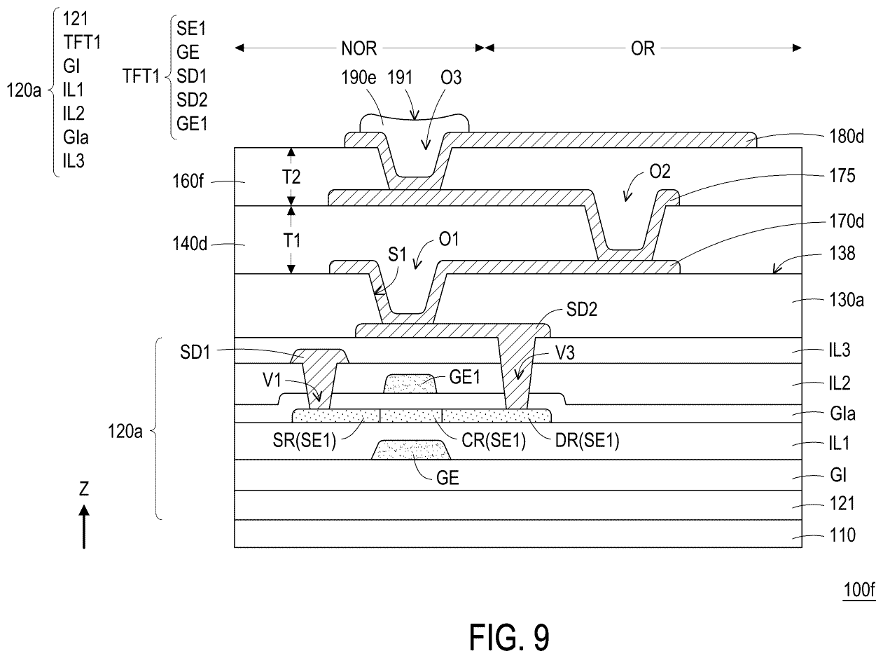

FIG. 9 is a schematic cross-sectional view of an electronic device according to a seventh embodiment of the disclosure. Referring to FIG. 9 and FIG. 7 at the same time, an electronic device 100f of the embodiment is similar to the electronic device 100d in FIG. 7, and an only difference there between is that in the electronic device 100f of the embodiment, the thickness of the second transparent organic layer 160f may be, for example, greater than 0.5 μm. In addition, the electronic device 100f of the embodiment may further include a third transparent organic layer 190e.

Specifically, referring to FIG. 9, in the embodiment, at least a part of the third transparent organic layer 190e is disposed in the third through hole O3 of the second transparent organic layer 160f, so that the liquid crystal at a place corresponding to the third through hole O3 is less likely to have the problem of light leakage due to poor liquid crystal arrangement.

The third transparent organic layer 190e has a recessed portion 191, and the recessed portion 191 may correspond to and overlap the third through hole O3 in the direction Z. The transparent organic layer 190 of the aforementioned embodiment may also include a recessed portion, but the disclosure is not limited thereto. In the disclosure, the transparent organic layers (including the first transparent organic layer, the second transparent organic layer and the third transparent organic layer) may all have recessed portions at positions correspond to the through holes (including the first through hole, the second through hole and the third through hole), but the disclosure is not limited thereto.

In the embodiment, since the thickness T2 of the second transparent organic layer 160f may be, for example, greater than 0.5 μm, the leveling effect of the second transparent organic layer 160f in filling the second through hole O2 of the first transparent organic layer 140d may be improved.

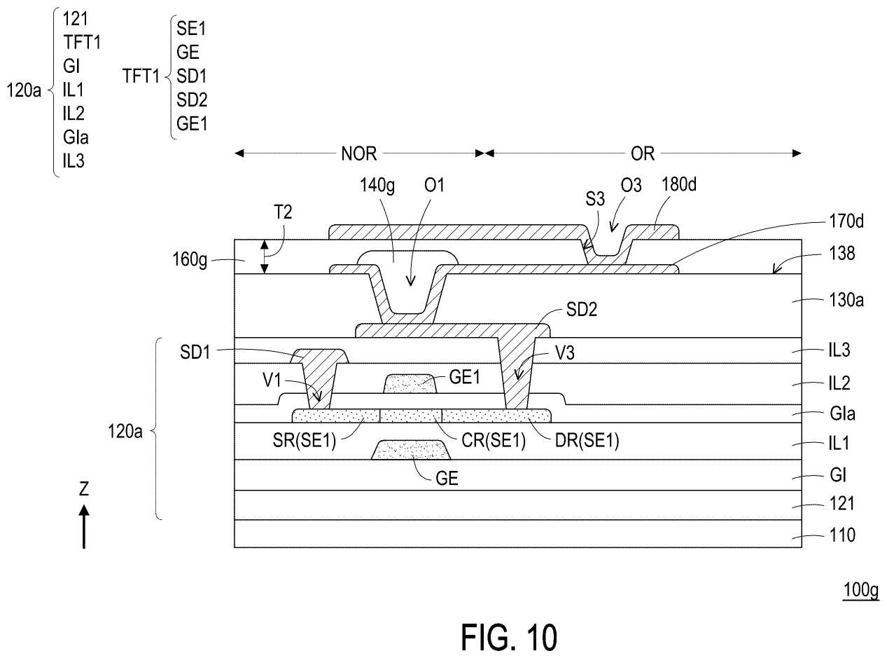

FIG. 10 is a schematic cross-sectional view of an electronic device according to an eighth embodiment of the disclosure. Referring to FIG. 10 and FIG. 7 at the same time, an electronic device 100g of the embodiment is similar to the electronic device 100d in FIG. 7, and an only difference there between is that in the electronic device 100g of the embodiment, the first transparent organic layer 140g does not cover the upper surface 138 of the color filter layer 130a of the opening region OR, thereby improving the transmittance of the opening region OR.

Specifically, referring to FIG. 10, in the embodiment, the first transparent organic layer 140g is disposed on the connection electrode 170d, and the first transparent organic layer 140g is disposed in the first through hole O1. The first transparent organic layer 140g does not contact the color filter layer 130a, or the first transparent organic layer 140g may cover a part of the color filter layer 130a, and at least a part of the color filter layer 130a is not covered by the first transparent organic layer 140g.

The second transparent organic layer 160g is disposed on the first transparent organic layer 140g, and the second transparent organic layer 160g may cover the color filter layer 130a, the connection electrode 170d and the first transparent organic layer 140g. The third through hole O3 of the second transparent organic layer 160g may be disposed in the opening region OR.

In summary, in the electronic device according to the embodiments of the disclosure, by disposing at least a part of the first transparent organic layer in the first through hole and the third through hole, the deeper through holes are filled up to mitigate the problems of light leakage and electrode overexposure, thereby improving display quality, process feasibility or product yield. A thickness of the first transparent organic layer may be, for example, less than 0.5 μm, so that the liquid crystal and the pixel electrode at a place corresponding to the second through hole are less likely to have the problems of light leakage due to poor liquid crystal arrangement and electrode overexposure. At least a part of the third transparent organic layer may also be disposed in the second through hole, so that the liquid crystal and the pixel electrode at a place corresponding to the second through hole are less likely to have the problems of light leakage due to poor liquid crystal arrangement and electrode overexposure. In addition, in some embodiments, since the second through hole is not connected to the first through hole, a leveling effect of the first transparent organic layer in filling the first through hole and a leveling effect of the second transparent organic layer in filling the second through hole may be improved, so that the liquid crystal and the pixel electrode at a place corresponding to the first through hole (or the second through hole) are less likely to have the problems of light leakage due to poor liquid crystal arrangement and electrode overexposure.

Finally, it should be noted that the above embodiments are only used to illustrate the technical solution of the disclosure rather than limit it. Although the disclosure has been described in detail with reference to the foregoing embodiments, those of ordinary skill in the art should understand that: the technical solutions described in the foregoing embodiments may still be modified, or some or all of the technical features may be equivalently replaced; and these modifications or substitutions do not cause the essence of the corresponding technical solution to depart from the scope of the technical solution of each embodiment of the disclosure.

What is claimed is:

1. An electronic device, comprising:
a substrate;
a driving circuit layer, disposed on the substrate;
a color filter layer, disposed on the driving circuit layer, and having a first through hole; and
a first transparent organic layer, disposed on the color filter layer, wherein at least a part of the first transparent organic layer is disposed in the first through hole,
wherein the first transparent organic layer covers at least a part of an upper surface of the color filter layer.

2. The electronic device as claimed in claim 1, further comprising:
a second transparent organic layer, disposed between the color filter layer and the first transparent organic layer.

3. The electronic device as claimed in claim 2, wherein the first transparent organic layer comprises a second through hole, the second transparent organic layer comprises a third through hole, and the electronic device further comprises:
an opening region; and
a non-opening region,
wherein the first through hole, the second through hole, and the third through hole are disposed in the non-opening region.

4. The electronic device as claimed in claim 2, wherein the first transparent organic layer comprises a second through hole, and the electronic device further comprises:
a third transparent organic layer, wherein at least a part of the third transparent organic layer is disposed in the second through hole.

5. The electronic device as claimed in claim 2, wherein the second transparent organic layer comprises a third through hole, the third through hole is connected to the first through hole, and the electronic device further comprises:
a connection electrode, disposed on the second transparent organic layer and in the third through hole and the first through hole.

6. The electronic device as claimed in claim 5, wherein the driving circuit layer comprises a thin film transistor, and the electronic device further comprises:
a transfer pad, disposed on the driving circuit layer, and electrically connecting the connection electrode and a drain electrode of the thin film transistor.

7. The electronic device as claimed in claim 5, wherein the third through hole has a side wall, a first bottom plane, and a second bottom plane, and the side wall of the third through hole is connected to a side wall of the first through hole through the first bottom plane or the second bottom plane.

8. The electronic device as claimed in claim 7, wherein a width of the first bottom plane is different from a width of the second bottom plane.

9. The electronic device as claimed in claim 5, wherein the first transparent organic layer comprises a second through hole, and the second through hole overlaps the third through hole.

10. The electronic device as claimed in claim 1, further comprising:
a second transparent organic layer, disposed on the first transparent organic layer.

11. The electronic device as claimed in claim 10, wherein the first transparent organic layer comprises a second through hole, the second transparent organic layer comprises a third through hole, and the electronic device further comprises:
an opening region; and
a non-opening region,
wherein the second through hole is disposed in the opening region, and the third through hole is disposed in the non-opening region.

12. The electronic device as claimed in claim 11, further comprising:
a third transparent organic layer, wherein at least a part of the third transparent organic layer is disposed in the third through hole.

13. The electronic device as claimed in claim 12, wherein the third transparent organic layer has a recessed portion, and the recessed portion corresponds to the third through hole.

14. The electronic device as claimed in claim 11, further comprising:
a connection electrode, disposed on the color filter layer and in the first through hole; and
another connection electrode, disposed on the first transparent organic layer and in the second through hole.

15. The electronic device as claimed in claim 14, wherein the driving circuit layer comprises a thin film transistor, the connection electrode is electrically connected to a drain electrode of the thin film transistor, and the another connection electrode is electrically connected to the connection electrode.

16. The electronic device as claimed in claim 10, wherein a thickness of the second transparent organic layer is smaller than a thickness of the first transparent organic layer.

17. The electronic device as claimed in claim 10, wherein a thickness of the color filter layer is greater than a thickness of the first transparent organic layer.

18. The electronic device as claimed in claim 10, wherein the first transparent organic layer does not contact the color filter layer.

19. The electronic device as claimed in claim 1, wherein the driving circuit layer comprises a thin film transistor, the thin film transistor has a drain electrode, and the electronic device further comprises:
a connection electrode; and
a pixel electrode, electrically connected to the drain electrode through the connection electrode,
wherein the color filter layer is disposed between the connection electrode and the drain electrode.

20. The electronic device as claimed in claim 1, wherein the driving circuit layer comprises a thin film transistor, and the electronic device further comprises:
an opening region; and
a non-opening region,
wherein the first through hole is disposed in the non-opening region, and the first through hole overlaps the thin film transistor.
